(19) United States
(12) Patent Application Publication
(10) Pub. No.: US 2004/0006636 A1
(43) Pub. Date: Jan. 8, 2004

(54) Optimized digital media delivery engine

(76) Inventors: Richard T. Oesterreicher, Naples, FL (US); Craig Murphy, Kirkland, WA (US); George Wright, Duvall, WA (US); Greg Ansley, Alpharetta, GA (US)

Correspondence Address: PENNIE AND EDMONDS, 1155 AVENUE OF THE AMERICAS, NEW YORK, NY, 100362711

(21) Appl. No.: 10/369,307

(22) Filed: Feb. 19, 2003

Related U.S. Application Data
(60) Provisional application No. 60/374,086, filed on Apr. 19, 2002.
(60) Provisional application No. 60/374,090, filed on Apr. 19, 2002.
(60) Provisional application No. 60/373,991, filed on Apr. 19, 2002.
(60) Provisional application No. 60/374,037, filed on Apr. 19, 2002.

(51) Int. Cl. G06F 15/16

(52) U.S. Cl. 709/231

(57) ABSTRACT

A digital media delivery engine adapted to store content in a media buffer dynamically generates wire data packets for transmission over a network. The digital media delivery engine eliminates the redundant copying of data and the shared I/O bus, bottlenecks typically found in a general-purpose PC. The digital media delivery engine is adapted to generate and deliver UDP/IP packets without requiring storage of an entire UDP datagram payload in a buffer while the UDP checksum is calculated. The checksum is dynamically calculated while IP packets that encapsulate payload data are generated and transmitted. After the payload of an entire UDP datagram has been encapsulated, the UDP checksum and other portions of the UDP header are then encapsulated in an IP packet and transmitted over the network.

### CROSS REFERENCE TO RELATED APPLICATIONS

This application claims benefit of U.S. provisional patent application serial No. 60/374,086, filed Apr. 19, 2002, entitled “Flexible Streaming Hardware,” U.S. provisional patent application serial No. 60/374,090, filed Apr. 19, 2002, entitled “Hybrid Streaming Platform,” U.S. provisional patent application serial No. 60/374,037, filed Apr. 19, 2002, entitled “Optimized Digital Media Delivery Engine,” and U.S. patent application Ser. No. 60/373,991, filed Apr. 19, 2002, entitled “Optimized Digital Media Delivery Engine,” each of which is hereby incorporated by reference for each of its teachings and embodiments.

### FIELD OF THE INVENTION

This invention relates to the field of digital media servers.

### BACKGROUND OF THE INVENTION

A digital media server is a computing device that streams digital media content onto a data transmission network. In the past, digital media servers have been designed using a general-purpose personal-computer (PC) based architecture in which PCs provide all significant processing relating to wire packet generation. But digital media are, by their very nature, bandwidth intensive and time sensitive, a particularly difficult combination for PC-based architectures whose stored-computing techniques require repeated data copying. This repeated data copying creates bottlenecks that diminish overall system performance especially in high-bandwidth applications. And because digital media are time sensitive, any such compromise of server performance typically impacts directly on the end-user's experience when viewing the media.

FIG. 1 demonstrates the steps required for generating a single wire packet in a traditional media server comprising a general-purpose-PC architecture. The figure makes no assumptions regarding hardware acceleration of any aspect of the PC architecture using add-on cards. Therefore, the flow and number of memory copies are representative of the prior art whether data blocks read from the storage device are reassembled in hardware or software.

Referring now to FIG. 1, in step 101, an application program running on a general-purpose PC requests data from a storage device. Using direct memory access (DMA), a storage controller transfers blocks of data to operating system (OS) random access memory (RAM). In step 102, the OS reassembles the data from the blocks in RAM. In step 103, the data is copied from the OS RAM to a memory location set aside by the OS for the user application (application RAM). These first three steps are performed in response to a user application's request for data from the memory storage device.

In step 104, the application copies the data from RAM into central processing unit (CPU) registers. In step 105, the CPU performs the necessary data manipulations to convert the data from file format to wire format. In step 106, the wire-format data is copied back into application RAM from the CPU registers.

In step 107, the application submits the wire-format data to the OS for transmission on the network and the OS allocates a new memory location for storing the packet format data. In step 108, the OS writes packet-header information to the allocated packet memory from the CPU registers. In step 109, the OS copies the media data from the application RAM to the allocated packet RAM, thus completing the process of generating a wire packet. In step 110, the completed packet is transferred from the allocated packet RAM to OS RAM.

Finally, the OS sends the wire packet out to the network. In particular, in step 111, the OS reads the packet data from the OS RAM into CPU registers and, in step 112, computes a checksum for the packet. In step 113, the OS writes the checksum to OS RAM. In step 114, the OS writes network headers to the OS RAM. In step 115, the OS copies the wire packet from OS RAM to the network interface device over the shared I/O bus, using a DMA transfer. In step 116, the network interface sends the packet to the network.

As will be recognized, a general-purpose-PC architecture accomplishes the packet-generation flow illustrated in FIG. 1 using a number of memory transfers. These memory transfers are described in more detail in connection with FIG. 2.

As shown in FIG. 2, the transfer from storage device 210 to file system cache 220 uses a fast Direct Memory Access (DMA) transfer. The transfer from file system cache 220 to file format data 230 requires each word to be copied into a CPU register and back out into random access memory (RAM). This kind of copy is often referred to as a mem copy (or memcpy from the C language procedure), and is a relatively slow process when compared to the wire speed at which hardware algorithms execute. The copy from file format data 230 to wire format data 240 and from wire format data 240 to OS Kernel RAM 250 are also mem copies. Network headers are added to the data while in the OS Kernel RAM 250, which requires a write of header information from the CPU to OS Kernel RAM. Determining the checksum requires a complete read of the entire data packet, and exhibits performance similar to a mem copy. The copy from the OS Kernel RAM 250 to Network Interface Card 260 is a DMA transfer across a shared bus. Thus, a total of 5 copies, and 1 complete iterative read into the CPU, of the payload data are required to generate a single network wire packet.

### SUMMARY OF THE INVENTION

A system and method are disclosed that overcome these deficiencies in the prior art and provide optimized delivery of digital media. In a preferred embodiment, a digital media delivery engine is provided that comprises dedicated hardware adapted to store content in a media buffer and dynamically generate wire data packets including the content for transmission over a network. The digital media delivery engine eliminates the redundant copying of data and the shared I/O bus, bottlenecks typically found in a general-purpose PC that delivers digital media. By eliminating these bottlenecks, the digital media delivery engine improves overall delivery performance and significantly reduces the cost and size associated with delivering digital media to a large number of end users.

In a preferred embodiment, the present system and method are adapted to generate and deliver UDP/IP packets without requiring storage of an entire UDP datagram payload in a buffer while the UDP checksum is calculated. More specifically, in a preferred embodiment, the UDP checksum is dynamically calculated while IP packets that encapsulate payload data are generated and transmitted over the network. After the payload of an entire UDP datagram has been encapsulated, the UDP checksum and other portions of the UDP header are then encapsulated in an IP packet and transmitted over the network.

In one aspect, the present invention is directed to a media delivery engine for providing streaming media to a client, comprising a digital media storage device; and a hardware engine, comprising a media buffer adapted to receive digital media assets directly from the digital media storage device, a processor adapted to generate wire data packets from digital media assets in the media buffer, and a first network interface coupled to the processor and adapted to transmit the wire data packets to the client.

In another aspect, the present invention is directed to a method of streaming digital media across a network, comprising transferring blocks of media asset data from a storage device directly to a media buffer, assembling media asset data from transferred blocks, reading media data from media buffer and generating network data packets while reading, and writing network data packets to the network.

In another aspect of the present invention, the step of generating further comprises calculating a checksum for the network data packet.

In another aspect, the present invention is directed to a method of generating and transmitting IP data packets that encapsulate a datagram having a checksum, comprising initializing a checksum register to zero, fragmenting the datagram into one or more frames, calculating the total of IP data octets in the frames, adding the total to the checksum register, generating a series of IP data packets using the frames, sending the series of IP data packets on to a network, generating a final IP data packet using the checksum register, and sending the final IP data packet on to the network.

In another aspect, the present invention is directed to a method of generating data packets in a network employing two or more hierarchical communications protocols where information in a datagram header of an upper-level protocol is derived from information included in the datagram payload and a lower-level protocol is responsible for segmenting and reassembling packets, comprising dynamically deriving datagram header information while generating and sending a series of data packets comprising data of the datagram payload, and generating a data packet comprising the derived datagram header information.

In another aspect of the present invention, the series of data packets is transmitted before generating a data packet comprising the derived datagram header information.

### BRIEF DESCRIPTION OF THE DRAWINGS

FIG. 1 is a flow chart illustrating a process for generating wire data packets in a general-purpose personal computer;

FIG. 2 is a block diagram illustrating memory transfers in a general-purpose personal computer used to generate a wire packet;

FIG. 3 is a block diagram illustrating components of a media delivery engine in one embodiment;

FIG. 4 is a flow chart illustrating a process for generating wire data packets in the media delivery engine;

FIG. 5 is a block diagram illustrating the format of a standard User Datagram Protocol (UDP) datagram encapsulated in an Internet Protocol (IP) packet;

FIG. 6 illustrates a UDP datagram encapsulated in a plurality of IP packets;

FIG. 7 is a flow chart illustrating a preferred embodiment of a process for efficient generation and transmission of a plurality of IP packets encapsulating a UDP datagram; and

FIG. 8 illustrates a UDP datagram encapsulated in a plurality of IP packets in accordance with the process of FIG. 7.

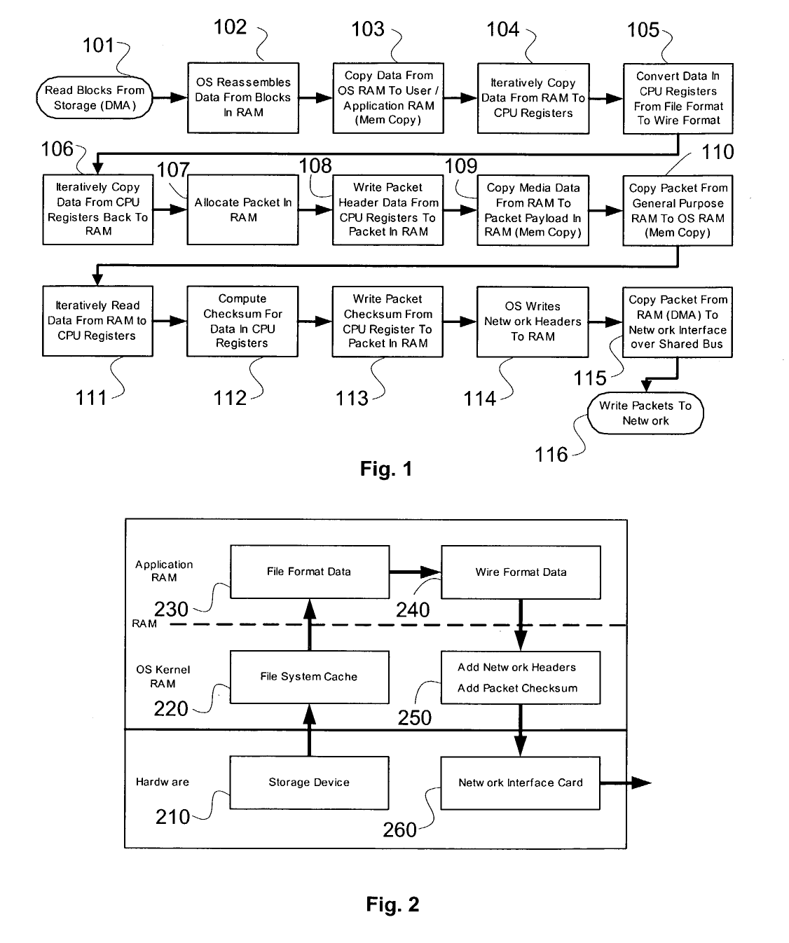

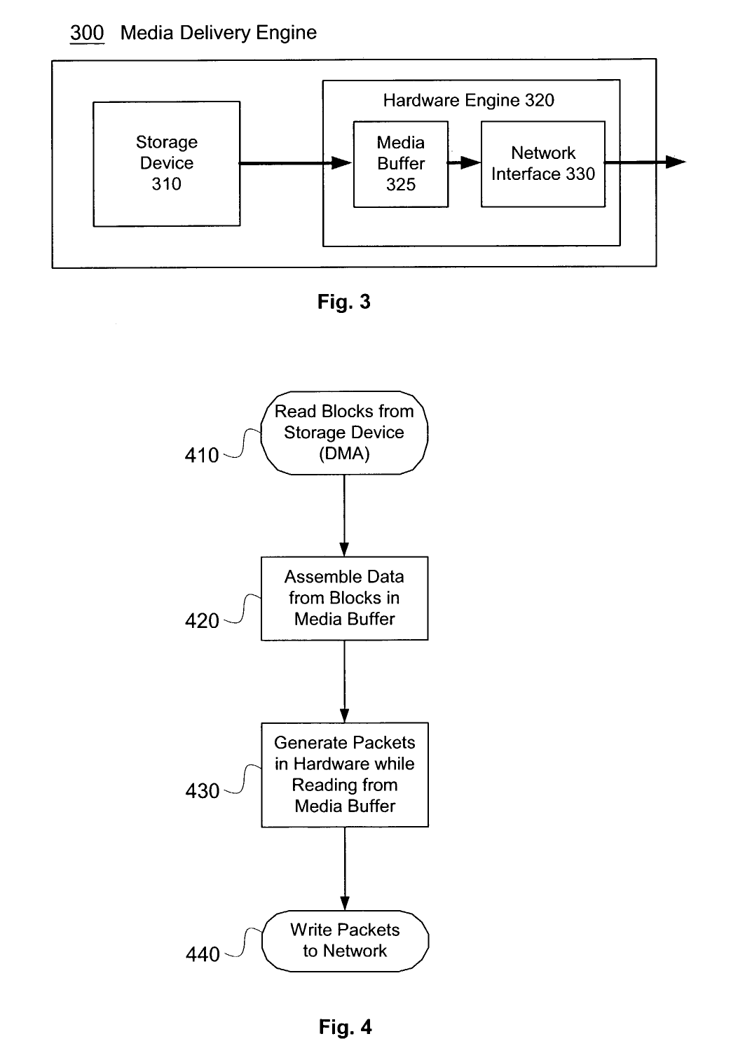

### DESCRIPTION OF THE PREFERRED EMBODIMENTS

In a preferred embodiment, the present system and method comprise a digital media delivery engine 300 that includes a storage device 310 and a hardware engine 320. Hardware engine 320 preferably comprises a media buffer 325 and a network interface 330.

Media delivery engine 300 is preferably adapted to generate wire data packets from data stored on storage device 310 and send them to clients across a network. In a preferred embodiment, data is copied from storage device 310 to media buffer 325 under control of a general-purpose computing device (not shown). A preferred architecture comprising this general-purpose computing device and media delivery engine 300 is described in U.S. patent application Ser. No. 10/___,___, entitled “Hybrid Streaming Platform,” filed on even date herewith (and identified by Pennie & Edmonds LLPs' docket no. 11055-005-999), which is hereby incorporated by reference in its entirety for each of its teachings and embodiments.

Hardware engine 320 converts the copied data in media buffer 325 from file format to wire format, generates data packets, and calculates checksums stored in packet headers without copying data from one memory location to another as in the general-purpose PC architecture described above. A preferred system and method for implementing these steps is described in U.S. patent application Ser. No. 10/___,___, entitled “Flexible Streaming Hardware,” filed on even date herewith (and identified by Pennie & Edmonds LLP's docket No. 11055-006-999), which is hereby incorporated by reference in its entirety for each of its teachings and embodiments.

Network interface 330 sends generated data packets on to the network. Because the generated data packets are fed directly to network interface 330 via a dedicated bus, the shared expansion bus bottleneck found in PC-based architectures is eliminated.

A preferred embodiment of a streaming process implemented by media delivery engine 300 is illustrated in FIG. 4. As shown in FIG. 4, in step 410, blocks of media data are read from storage device 3 1 0 and copied directly to media buffer 325 without a processor handling the data. Next, in step 420, hardware engine 320 reassembles the media data from the blocks stored in media buffer 325. This step is required because data packets are typically much smaller than the data blocks, so data designated for a packet may cross the boundary between blocks. Hardware engine 320 thus must reassemble the media data included in more than one block to form such a data packet.

In step 430, hardware engine 320 generates data packets while reading from media buffer 325. As part of the packet generation process, hardware engine 320 adds required header information to the packet, (such as network addresses and checksums) as the data is read from media buffer 325. This eliminates the need to temporarily write packet data to a buffer while the packet is assembled. Finally, in step 440, hardware engine 320 transfers the freshly generated data packets to network interface 330, which in turn writes the packets to a network. As noted, this process and a platform for implementing it are described in more detail in U.S. patent application Ser. Nos. 10/___,___, entitled “Flexible Streaming Hardware,” filed on even date herewith (and identified by Pennie & Edmonds attorney docket no. 11055-006-999), and 10/___,___, entitled “Hybrid Streaming Platform,” filed on even date herewith (and identified by Pennie & Edmonds LLPs' docket no. 11055-005-999), both of which are hereby incorporated by reference in their entirety for each of their teachings and embodiments.

One impediment to bufferless generation of wire data packets from media data is standard Internet Protocol (IP) packet fragmentation. In order to send a User Datagram Protocol (UDP) datagram across an IP network, the datagram is encapsulated in an IP packet. If the resultant IP packet is larger than the maximum transmission unit (MTU) of the underlying network link, the IP packet must be fragmented. Further details on the IP standard may, for example, be found in RFCs 791 and 815, each of which is hereby incorporated by reference in their entirety.

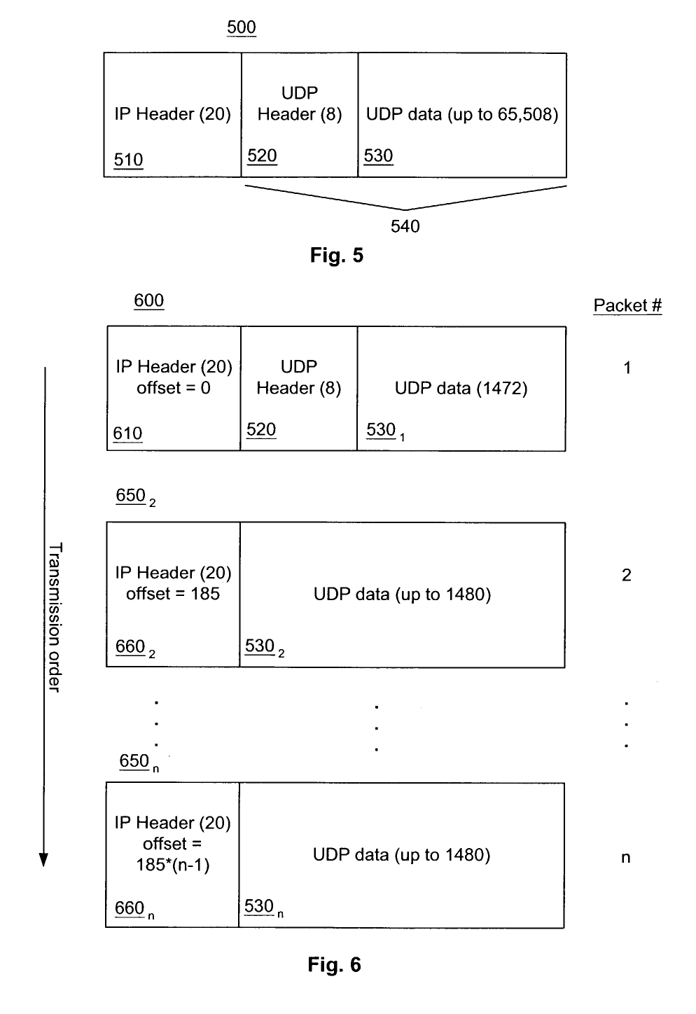

FIG. 5 is a block diagram illustrating the format of a standard IP packet encapsulating a UDP datagram. The maximum size of an IP packet is 65,536 octets. As shown in FIG. 5, an IP packet 500 consists of a 20 octet IP header 510, and a UDP datagram 540. UDP datagram 540 comprises an eight (8) octet UDP header 520 and up to 65,508 octets of UDP data 530. IP header 510 comprises a source IP address, a destination IP address, a packet identifier, an IP header checksum, and a fragmentation offset. UDP header 520 comprises a source port number, a destination port number, the number of octets in UDP data 530, and a checksum of the octets contained in UDP data 530. Further detail on the UDP standard may, for example, be found in RFC 768, which is hereby incorporated by reference in its entirety.

FIG. 6 is a block diagram illustrating the format of standard IP packets encapsulating a UDP datagram 540 when fragmentation of packet 500 is required to accommodate a network connection having an MTU smaller than that of packet 500. For purposes of the particular example in FIG. 6, it is assumed that the network connection has an MTU of 1500 octets.

As shown in FIG. 6, each IP packet in this example preferably comprises a 20 octet header and a payload of up to 1480 octets. UDP datagram 540 is segmented and placed into a first IP packet 600 (packet #1) and one or more subsequent IP packets 650 (packets #2 through n). The first IP packet 600 comprises an IP header 610 (20 octets), UDP header 520 (8 octets), and the first 1472 octets of UDP data 530₁. IP header 610 contains a flag indicating that the packet is fragmented and a fragmentation offset field that is set to zero. Each subsequent IP packet 650 consists of an IP header 660 and includes up to 1480 octets of the remaining UDP data 530. The fragmentation offset field in each IP header 660 indicates the number of eight octet blocks from the beginning of the data area of the unfragmented IP packet where the data belongs. For example, since the first IP packet contained 1480 octets of data, the offset in the second IP packet would be 185. Each subsequent packet would have an offset of 185 times the packet number of the prior packet.

In the above example, the entire UDP datagram must be stored in a buffer before it can be encapsulated in IP packets. This is because the first IP packet 600 includes the UDP checksum which is a function of the entire UDP datagram payload. Accordingly, a buffer large enough to hold the entire UDP datagram payload is required, so that the payload's checksum can be calculated and inserted into the UDP header encapsulated in IP packet 600.

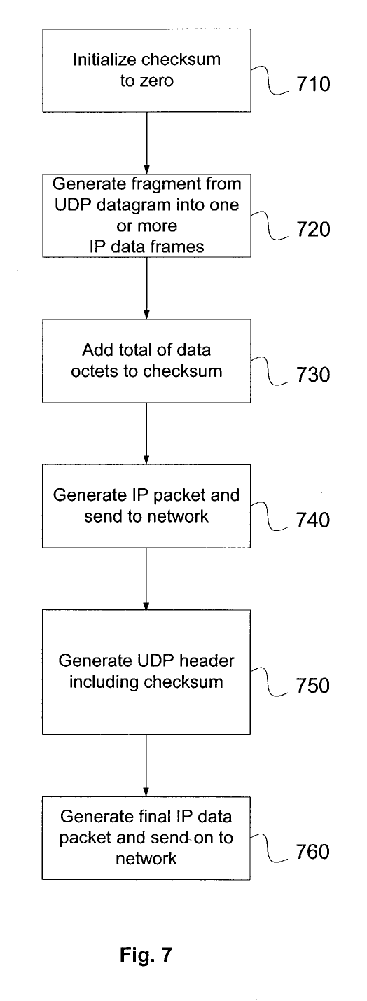

In a preferred embodiment, the present system and method avoid the need for such a buffer by changing the order in which IP packets are generated and transmitted. More specifically, since IP packets may be transmitted across different paths in an IP network, the order of their arrival may be different from the order of their transmission. To address this, IP is adapted to allow reconstruction of a datagram from its fragments, even if the fragments are received out of order. The preferred embodiment takes advantage of this capability and intentionally changes the order of IP packet fragments generated and transmitted. This preferred embodiment is described in connection with FIG. 7.

As shown in FIG. 7, in step 710, digital media delivery engine 300 initializes a checksum register to zero. In step 720, as content is streamed from the media buffer, digital media delivery engine 300 dynamically fragments the data into a size suitable for the network connection via which the content is to be transmitted. For example, if the MTU is 1500 octets, media delivery engine 300 dynamically fragments the content stream into fragments of 1480 bytes in length (to allow room for the 20 octet IP header). In step 730, media delivery engine 300 calculates the total of the octets in the fragment and adds the total to the checksum maintained in the checksum register.

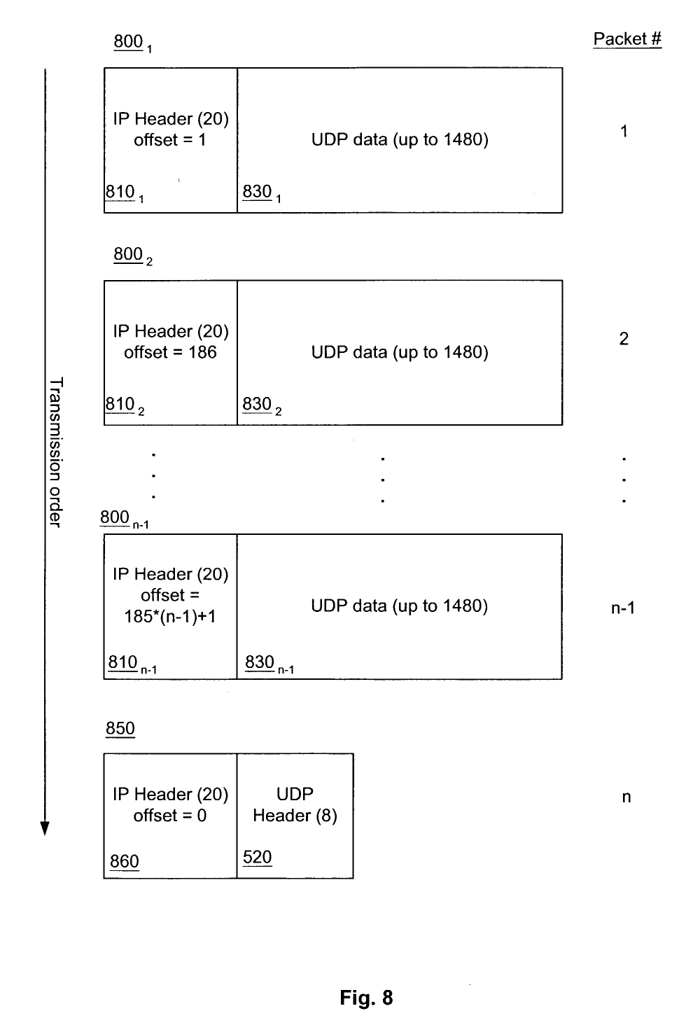

As each fragment is generated, media delivery engine 300 dynamically generates an IP header for the fragment and provides a complete IP packet 800 to the network (step 740). FIG. 8 illustrates a preferred embodiment of the IP packets 800 generated in steps 720-740.

As shown in FIG. 8, each IP packet 800 (packets 1 through n−1) comprises an IP header 810 and an IP data frame 830 with up to 1480 octets of payload (UDP data). IP header 810 comprises a header identifier that is the same for all packets in the series. IP header 810 also comprises a fragmentation offset set to one plus the prior packet number times 185. For example, the first IP header sent will have a fragmentation offset of one (1), the second IP header will have a fragmentation offset of 186, etc. As described below, the fragmentation offset stored in each IP header 810 allows the client to properly reassemble the transmitted data from the IP packet fragments, even if some or all of the packets arrive in a different order than they were transmitted.

Returning to FIG. 7, when the total number of data octets in the IP packet series reaches 65,508 octets (i.e., the maximum number of payload octets in a UDP datagram), media delivery engine 300 dynamically generates a UDP header for the datagram including the calculated checksum stored in the checksum register (step 750). In step 760, the UDP header is encapsulated in an IP packet fragment 850 that includes an IP header 860 having the same identifier used in series 800. The fragmentation offset of IP header 860 is set to zero and the packet is transmitted via network interface 330 onto the network. A preferred embodiment of IP packet 850 is shown in FIG. 8.

At the client, the payloads of IP packets 800, 850 are placed in a buffer in accordance with the fragmentation offset value included in IP header 810, 860 of their respective packets. Once all the packets are received, the buffer contains a complete UDP datagram.

It should be recognized that although the above system and method has been described in connection with a UDP/IP encapsulation, this system and method may be applied in many other cases. For example, the above system and method may be applied in any encapsulation scheme employing two or more hierarchical protocols where information presented in a upper-level datagram header is calculated using some or all of the datagram payload and a lower-level protocol is responsible for segmenting and reassembling fragmented data packets independent of their delivery order.

While the invention has been described in conjunction with specific embodiments, it is evident that numerous alternatives, modifications, and variations will be apparent to those skilled in the art in light of the foregoing description.

What is claimed is:

1. A media delivery engine for providing streaming media to a client, comprising:
a digital media storage device; and
a hardware engine, comprising:
a media buffer adapted to receive digital media assets directly from the digital media storage device;
a processor adapted to generate wire data packets from digital media assets in the media buffer; and
a first network interface coupled to the processor and adapted to transmit the wire data packets to the client.

2. A method of streaming digital media across a network, comprising:
transferring blocks of media asset data from a storage device directly to a media buffer;
assembling media asset data from transferred blocks;
reading media data from media buffer and generating network data packets while reading; and
writing network data packets to the network.

3. The method of claim 2, wherein the step of generating further comprises calculating a checksum for the network data packet.

4. A method of generating and transmitting IP data packets that encapsulate a datagram having a checksum, comprising:
initializing a checksum register to zero;
fragmenting the datagram into one or more frames;
calculating the total of IP data octets in the frames;
adding the total to the checksum register;
generating a series of IP data packets using the frames;
sending the series of IP data packets on to a network;
generating a final IP data packet using the checksum register; and
sending the final IP data packet on to the network.

5. A method of generating data packets in a network employing two or more hierarchical communications protocols where information in a datagram header of an upper-level protocol is derived from information included in the datagram payload and a lower-level protocol is responsible for segmenting and reassembling packets, comprising:
dynamically deriving datagram header information while generating and sending a series of data packets comprising data of the datagram payload; and
generating a data packet comprising the derived datagram header information.

6. The method of claim 5 wherein the series of data packets is transmitted before generating a data packet comprising the derived datagram header information.
